(19) United States
(12) Patent Application Publication
(10) Pub. No.: US 2026/0362041 A1
(43) Pub. Date: Nov. 12, 2026

(54) PORTABLE DEVICE INCLUDING A CARABINER

(71) Applicant: MILWAUKEE ELECTRIC TOOL CORPORATION, Brookfield, WI (US)

(72) Inventors: Luke I. Bradley, Oconomowoc, WI (US); David C. Bartok, Milwaukee, WI (US); Chelsea L. Rubietta, Oak Creek, WI (US); Jacob D. Hadfield, Mukwonago, WI (US); Gregory R. Strommen, Lannon, WI (US)

(21) Appl. No.: 19/666,431

(22) Filed: May 4, 2026

Related U.S. Application Data
(60) Provisional application No. 63/802,708, filed on May 9, 2025.

(51) Int. Cl. H04R 1/02; F16B 45/02; F16M 13/02

(52) U.S. Cl. CPC H04R 1/026; F16B 45/023; F16B 45/024; F16M 13/022; H04R 1/023

(57) ABSTRACT

A portable device includes a housing, an output element supported by the housing, and a battery receptacle supported by the housing for selectively receiving a battery configured to electrically power the output element. The portable device further includes a mounting assembly located on the housing, the mounting assembly including a carabiner having a frame defining a first end and a second end and coupled to the housing, the carabiner being movable between a first position corresponding to a stowed configuration adjacent the housing and a second position corresponding to a partially deployed configuration in which the carabiner is displaced away from the housing, and the mounting assembly further including a plurality of magnets supported by the housing and configured to magnetically couple the portable device to a mounting surface.

### CROSS-REFERENCE TO RELATED APPLICATION

This application claims priority to U.S. Provisional Application No. 63/802,708, filed May 9, 2025, the entire contents of which are incorporated by reference herein.

### FIELD OF THE DISCLOUSRE

The present disclosure relates to portable devices, such as audio output devices, and more particularly, to mounting assemblies for portable devices.

### BACKGROUND OF THE DISCLOSURE

Wireless speakers are easily portable and can be placed in various locations during use. Conventional portable wireless speakers utilize various types of mounting assemblies, such as hooks, handles, magnets, straps, etc., to mount the speaker to various items, such as chairs, walls, beams, etc.

### SUMMARY OF THE DISCLOSURE

The present disclosure provides a portable device including a housing, an output element supported by the housing, and a battery receptacle supported by the housing for receiving a battery that is configured to electrically power the output element. The portable device also includes a mounting assembly located on the housing. The mounting assembly includes a carabiner having a frame pivotably coupled to a side of the housing and movable between a first position, in which the frame is adjacent the housing, and a second position, in which the frame is spaced from the housing. The mounting assembly also includes a magnet located on the side of the housing and configured to magnetically couple the portable device to a mounting surface.

The present disclosure provides a portable device including a housing, an output element supported by the housing, and a battery receptacle supported by the housing for receiving a battery that is configured to electrically power the output element. The portable device also includes a mounting assembly located on the housing. The mounting assembly includes a carabiner having a frame defining a first leg and a second leg, the frame movable relative to the housing between a first position, in which the carabiner is in a compact orientation, a second position, in which the carabiner is displaced outwardly from the housing compared to the first position, and a third position, in which the carabiner is displaced further outwardly from the housing compared to the second position and is rotatable relative to the housing.

The present disclosure provides a portable device including a housing, an output element supported by the housing, and a battery receptacle supported by the housing for receiving a battery configured to electrically power the output element. The portable device also includes a mounting assembly located on the housing. The mounting assembly includes a carabiner coupled to the housing and movable between a first position, in which the carabiner is flush with or recessed relative to a surface of the housing, and a second position, in which the carabiner is displaced outwardly from the housing. The mounting assembly also includes a plurality of magnets supported by the housing and configured to magnetically couple the portable device to a mounting surface.

Other features and aspects of the disclosure will become apparent by consideration of the following detailed description and accompanying drawings.

### BRIEF DESCRIPTION OF THE DRAWINGS

FIG. 1 is a perspective view of a portable device according to an embodiment of the present disclosure.

FIG. 2 is a rear perspective view of the portable device of FIG. 1, the portable device including a mounting assembly in a stowed position.

FIG. 3 is another rear perspective view of the portable device of FIG. 1, illustrating the mounting assembly in an extended position.

FIG. 4 is an enlarged, perspective view of a portion of the portable device of FIG. 1.

FIG. 5 is a partial-exploded view of the portable device of FIG. 1.

FIG. 6A is a perspective view of a portion of a portable device including a mounting assembly according to another embodiment, the mounting assembly in a stowed position.

FIG. 6B is a perspective view of the portion of the portable device of FIG. 6A with the mounting assembly in an intermediate position.

FIG. 6C is a perspective view of the portion of the portable device of FIG. 6A with the mounting assembly in an extended position.

FIG. 7 is a schematic of a portable device including either of the mounting assemblies of FIGS. 1-5 and FIGS. 6A-6C.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

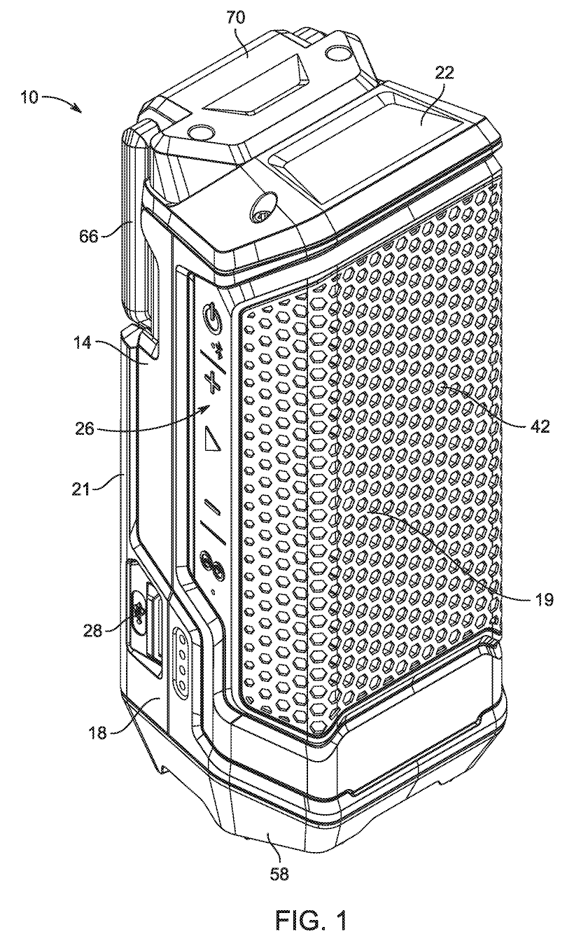

FIG. 1 illustrates a portable device 10. In the illustrated embodiment, the portable device 10 is a portable speaker. In other embodiments, the portable device may be another type of device, such as a portable light, a portable fan, a power tool, and the like.

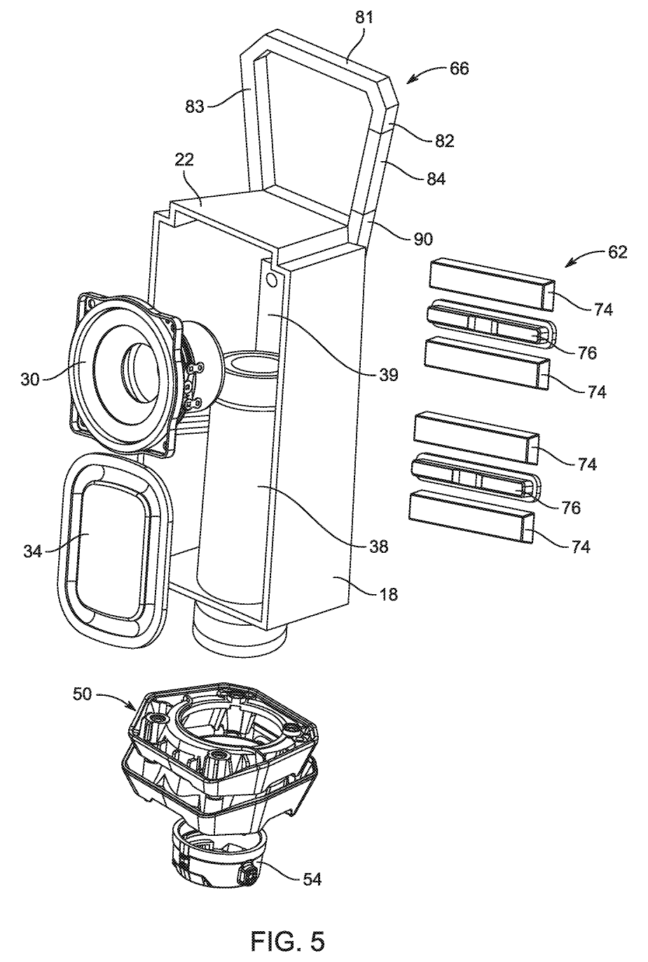

The illustrated portable device 10 includes a main body or housing 14 having a base 18 for supporting the portable device 10, an upper side 22 opposite the base 18, a first or front side 19 extending between the base 18 and the upper side 22, and a second or rear side 21 opposite the front side 19 and extending between the base 18 and the upper side 22. The housing 14 receives and supports various audio components. The audio components may be considered an output element of the portable device 10. For example, as shown in FIG. 5, the audio components may include a speaker driver 30 and a passive radiator 34 that work together to output sound. The audio components may also be referred to simply as a speaker. In other embodiments, the output element of the portable device 10 may be, for example, a light source, a fan, a motor‑driven tool output supported by the housing 14, a heating device, and/or a cooling device, among other possibilities.

In the illustrated embodiment, the audio components are powered by a battery 38 (FIG. 5). The battery 38 may be a rechargeable battery. The battery 38 is selectively received in a battery receptacle 39. The illustrated battery receptacle 39 is positioned within the housing 14. Specifically, the battery receptacle 39 is positioned within the housing 14 in a region defined between the base 18 and the upper side 22. The battery receptacle 39 is also between the front side 19 and the rear side 21. In other embodiments, the battery receptacle 39 may be supported on an outer surface of the housing 14.

Referring back to FIG. 1, the housing 14 also includes a grille 42 positioned on the front side 19 of the housing 14. The grille 42 extends over and protects the audio components positioned inside the housing 14.

The portable device 10 also includes a user interface. The user interface may include a plurality of different buttons and/or displays related to the operation of the portable device 10. In the illustrated embodiment, the user interface includes a control bar 26. The control bar 26 is located adjacent the grille 42. The illustrated control bar 26 includes an ON/OFF button, a wireless connectivity button, a battery indicator, playback controls, such as volume controls, start/stop controls, etc. In some embodiments, the control bar 26 may be backlit by LEDs. In other embodiments, the user interface may have other configurations. For example, the user interface may include multiple control bars that may be located elsewhere on the housing 14. In some embodiments, the portable device 10 includes a second control bar located on the upper side 22 of the housing 14.

In the illustrated embodiment, the portable device 10 includes a port 28. The port 28 is located on the housing. The port 28 may be, for example, a USB port (for example, USB-C) configured to receive a USB connector to selectively electrically charge the battery 38. In another example, the port 28 may be a charging port electrically coupled to the battery receptacle 39.

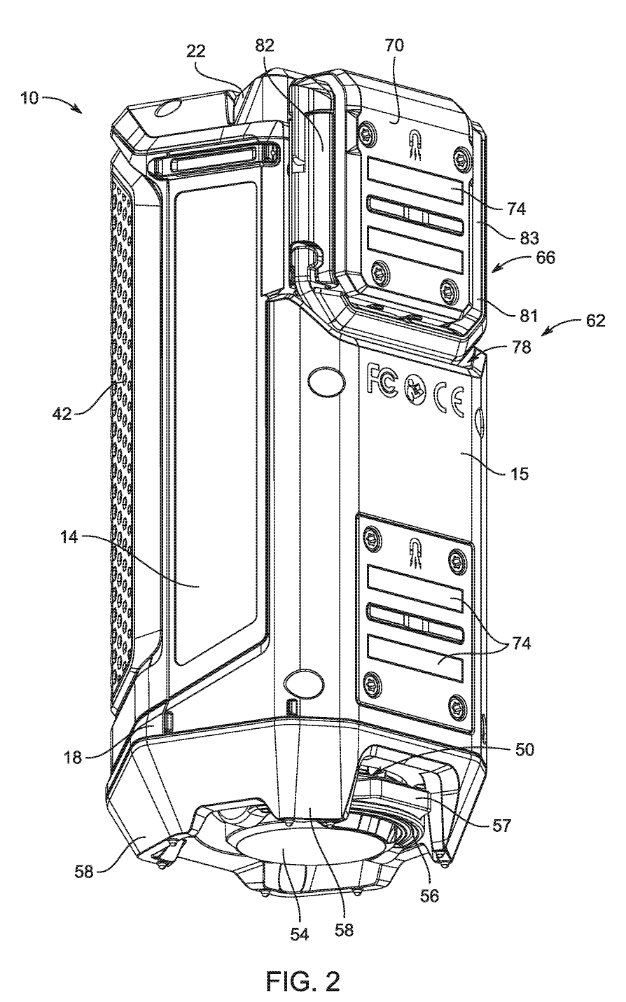

With reference to FIGS. 1–2, the base 18 of the portable device 10 includes a battery door 50. The battery door 50 is secured to the base 18 by a removable cap 54. The removable cap 54 engages the base 18 to seal internal components of the housing 14 from external environmental conditions, including moisture and debris. In the illustrated embodiment, the battery door 50 forms a portion of the base 18. The removable cap 54 is rotatable relative to the base 18 to permit removal of the battery door 50 from the housing 14. In some embodiments, the removable cap 54 includes a threaded connection with the base 18. In other embodiments, the removable cap 54 includes another rotational coupling, such as a bayonet‑style connection. The removable cap 54 includes a handle 56 that pivots relative to the removable cap 54 between a stowed position and an extended position. In the illustrated embodiment, the handle 56 is pivotable relative to the removable cap 54 along an angular range of 180 degrees. In other embodiments, the handle 56 may have an angular range of 270 degrees. In other embodiments, the handle 56 may have an angular range that is greater than or less than 180 degrees. The handle 56 is graspable by a user to rotate the removable cap 54 relative to the base 18. In the illustrated embodiment, the handle 56 includes a tab 57 that extends outwardly from the handle 56 to facilitate gripping of the handle 56. In other embodiments, the battery door 50 may include a pivotable door, rather than the rotatable cap 54.

In the illustrated embodiment, the portable device 10 includes a plurality of support feet 58 for supporting the portable device 10 on a surface. For example, the illustrated portable device 10 includes four support feet 58 formed on the base 18. In some embodiments, the portable device includes a horizontal support foot on a side of the housing 14 between the front side 19 and the rear side 21. The horizontal support foot on the side of the housing 14 may be larger than the support feet 58 on the base 18. The support feet 58 support the portable device 10 in an upright or vertical position. In some embodiments, at least one support foot 58 is integrally formed with the base 18. In some embodiments, at least one support foot 58 is separate from the base 18 and couplable to the base 18. In some embodiments, at least one support foot 58 extends from the battery door 50. The support feet 58 are formed on both the battery door 50 and the base 18. In other embodiments, the portable device 10 can include fewer or more support feet 58 that can vary in both size and shape and be located on other parts of the housing 14. In some embodiments, the support feet 58 are formed from rubber or an elastomeric material. In other embodiments, the support feet 58 are formed from a plastic.

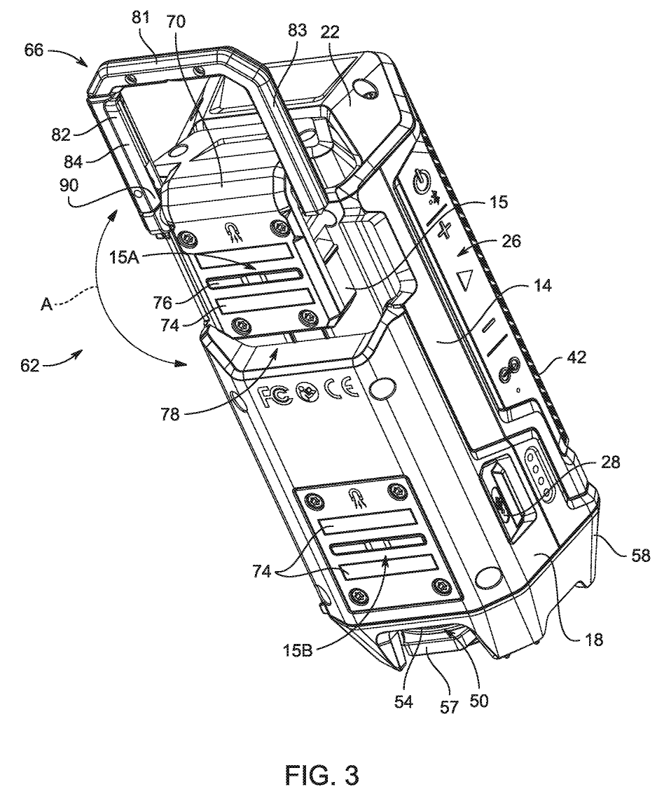

With reference to FIGS. 2-3, the portable device 10 further includes a mounting assembly 62. The mounting assembly 62 is positioned on the rear side 21 of the housing 14, opposite the grille 42. That is, the mounting assembly 62 is positioned on a side of the housing 14 opposite from a side where the output element outputs its output (e.g., sound, light, moving air, etc.). The mounting assembly 62 is coupled to a rear surface 15 of the housing 14. The illustrated mounting assembly 62 includes a carabiner 66 and a plurality of magnets 74. The carabiner 66 is coupled to the rear surface 15 adjacent the upper side 22 of the housing 14. The carabiner 66 is pivotably coupled to the rear surface 15 of the housing 14 via a hinged connector 70. The carabiner 66 pivots about an axis that is perpendicular to a length of the portable device 10 measured between the base 18 and the upper side 22 of the housing 14. Specifically, the carabiner 66 is pivotable about a hinged connector 70 relative to the rear surface 15 such that the carabiner 66 can extend outwardly from the housing 14 and past the upper side 22. As the carabiner 66 pivots about the hinged connector 70, an angle A is formed between the carabiner 66 and the rear surface 15. In some embodiments, the angle A does not exceed 180 degrees. In other embodiments, the angle A may be greater than 180 degrees. For example, in some embodiments, the angle A may be 90 degrees or less such that the carabiner 66 does not extend past the upper side 22 of the housing 14.

The carabiner 66 is selectively movable between a first or stowed position (FIG. 2) and a second or extended position (FIG. 3). The angle A is 0 degrees when the carabiner 66 is in the stowed position and approximately 180 degrees when the carabiner 66 is in the extended position. In the stowed position, the carabiner 66 is positioned within a recess 78 formed on the rear surface 15 of the housing 14. The recess 78 allows the carabiner 66 to be stowed such that the carabiner 66 is flush with the rear surface 15 to maintain a uniform contact surface between the magnets 74 and the selected mounting surface. In some embodiments, the recess 78 allows the carabiner 66 to sit below (that is, slightly recessed relative to) the rear surface 15. In the extended position, the carabiner 66 is displaced outwardly from the housing 14. In some embodiments, the carabiner 66 may be fixed in a third or intermediate position between the stowed position and the extended position at the angle A.

With continued reference to FIGS. 2-3, the magnets 74 are positioned on the rear surface 15 of the housing 14. In the illustrated embodiment, the magnets 74 are arranged in two pairs of two magnets 74. The magnets 74 are arranged relative to each other on the rear surface 15 to facilitate the uniform attachment of the portable device 10 to a metallic surface (for example, a steel stud). Specifically, the magnets 74 occupy a first region 15A and a second region 15B of the rear surface 15 separated from the first region by the recess 78. In some embodiments, the magnets 74 can be arranged on the rear surface 15 in other patterns or arrangements. In still other embodiments, the magnets 74 can be positioned on a different side of the housing 14 than the carabiner 66. When in the stowed position, the carabiner 66 surrounds at least one of the magnets 74 that occupy the first region 15A of the rear surface 15. In other words, the carabiner 66 forms at least part of a perimeter around at least one of the magnets 74 when the carabiner 66 in the stowed position. In the illustrated embodiment, when in the stowed position, the carabiner 66 surrounds two of the magnets 74. In other embodiments, the carabiner 66 may surround fewer or more magnets 74 when in the stowed position. The rear surface 15 of the housing 14 includes a plurality of rubber pads 76. The rubber pads 76 may extend from the rear surface 15 slightly further than the magnets 74 to inhibit the magnets 74 and the rear surface 15 from directly contacting the metallic surface. In some embodiments, the rubber pads 76 may cover the magnets 74.

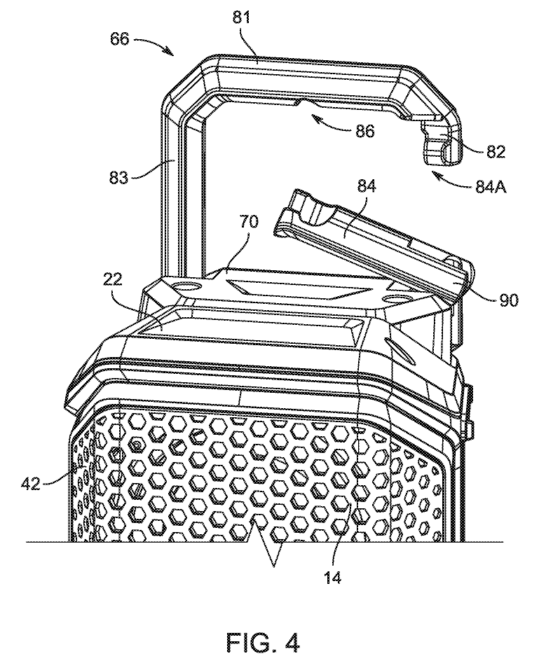

With reference to FIG. 4, the carabiner 66 includes a frame 81 having a first leg 82 and a second leg 83 that are each pivotably coupled to the hinged connector 70. In the stowed position of the carabiner 66, the frame 81 is adjacent the housing 14. In the extended position of the carabiner 66, the frame 81 is spaced from the housing 14. In some embodiments, the first leg 82 and the second leg 83 are connected to the hinged connector 70 via an O-ring connection (not shown). The O-ring connection provides resistance to hold the carabiner 66 in positions relative to the housing 14. In other embodiments, the first leg 82 and the second leg 83 may be connected to the hinged connector 70 via a detent connection that holds the carabiner 66 in one or more discrete positions relative to the housing 14.

The carabiner 66 also includes a gate 84 formed on the first leg 82. In a first or resting position of the gate 84, a length of the gate 84 extends in a direction parallel to a length of the first leg 82. In some embodiments, the gate 84 is spring biased to the resting position. Movement of the gate 84 defines a second or open position of the gate 84. In the open position of the gate 84, an opening 84A is formed in the frame 81 to receive a mounting surface. The gate 84 is pivotable about a pivot point 90 to form the opening 84A in the carabiner 66 such that the carabiner 66 can be hooked onto a mounting surface. In the illustrated embodiment, the pivot point 90 is formed as part of the first leg 82 of the carabiner 66. In other embodiments, the gate 84 and pivot point 90 can be located elsewhere on the carabiner 66. The open position of the gate 84 may also be referred to as a fourth position of the carabiner 66. Additionally, in the illustrated embodiment, the carabiner 66 also includes an arcuate cutout 86 formed in the frame 81. The arcuate cutout 86 is shaped to receive a fastener, such as a nail, so the carabiner 66 can be hung from the fastener. In some embodiments, the frame 81 includes a textured surface. In some embodiments, the frame 81 includes metal.

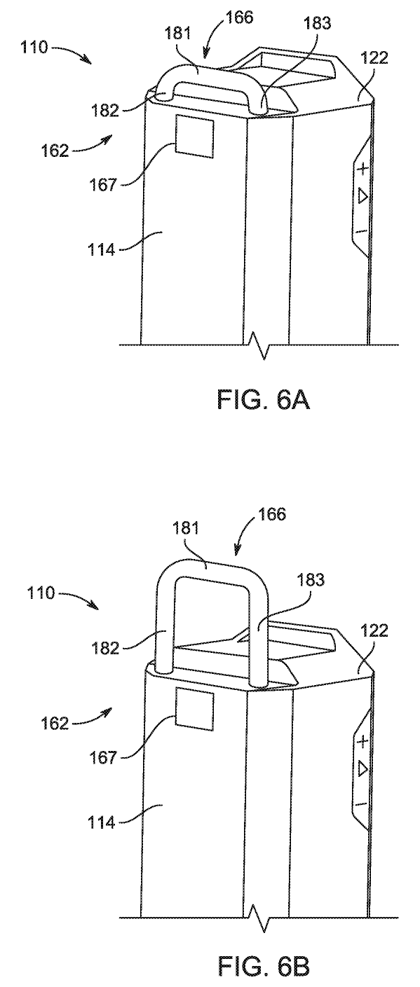

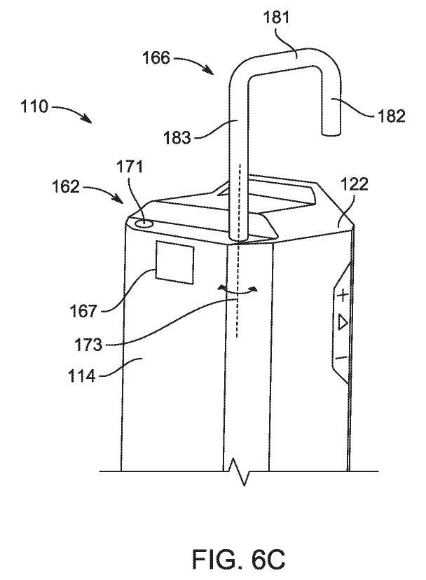

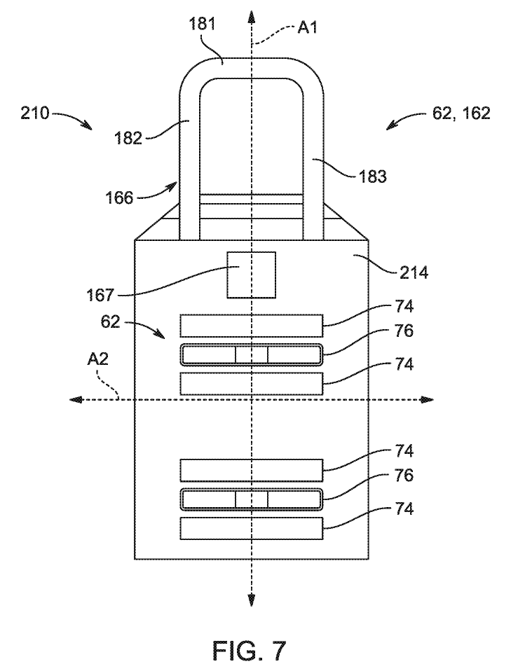

FIGS. 6A-6C illustrate another embodiment of a portable device 110 with like components and features of the portable device 10 plus “100.” The portable device 110 includes a housing 114 and a mounting assembly 162 for facilitating the attachment of the portable device 110 to a mounting surface. In the illustrated embodiment, the mounting assembly 162 includes a carabiner 166 located on an upper side 122 of the housing 114. The carabiner 166 defines a frame 181 having a first leg 182 and a second leg 183 are received within the housing 114 via apertures 171 (FIG. 6C).

The carabiner 166 is movable between a first or stowed position (FIG. 6A), a second or intermediate position (FIG. 6B), and a third or extended position (FIG. 6C). In the first position, the carabiner 166 is positioned adjacent the upper side 122 of the housing 114 in a compact orientation. In this position, most of the first leg 182 and the second leg 183 are received within the housing 114 such that only small ends of the first leg 182 and the second leg 183 extend out of the housing 114. A cross member of the carabiner 166 extending between the first leg 182 and the second leg 183 is also positioned outside of the housing 114, but is adjacent or near the upper side 122 of the housing 114. As such, the carabiner 166 forms a closed loop with the housing 114. In some embodiments, the cross member may contact the upper side 122 of the housing 114 in this position.

In the intermediate position, the first leg 182 and the second leg 183 of the carabiner 166 are slidable out of the apertures 171 in the housing 114 to move the carabiner 166 away from the housing 114. In the intermediate position, the first leg 182 and the second leg 183 remain at least partially received within the apertures 171. As such, the carabiner 166 still forms a closed loop with the housing 114. The carabiner 166 can be locked in the intermediate position to inhibit movement of the first leg 182 and the second leg 183 of the carabiner 166 within the housing 114. For example, the carabiner 166 can be moved (e.g., slid) laterally to lock the carabiner 166 within a detent 167 of the housing 114.

From the intermediate position, the carabiner 166 is movable to the extended position where the first leg 182 and the second leg 183 are moved further away from the housing 114 until the first leg 182 moves out from within the aperture 171. In this position, the carabiner 166 no longer forms a closed loop with the housing 114. In the extended position, the second leg 183 of the carabiner 166 can be rotated about a rotational axis 173 defined by the second leg 183 of the carabiner 166 to reposition the first leg 182 in a desired orientation to hang the carabiner 166 onto a mounting surface. In some embodiments, when the carabiner 166 is in the extended position, the carabiner 166 functions as a hook.

In some embodiments, the mounting assembly 162 may also include a plurality of magnets arranged on the housing 114 to magnetically coupled the portable device 110 to a metallic mounting surface, similar to the magnets 74 described above. In some embodiments, the magnets are located on a surface of the housing 114 opposite the upper side 122. In some embodiments, the magnets and the carabiner 166 provide alternative attachment modes for the portable device 110.

FIG. 7 illustrates another portable device 210. The portable device may include either of the mounting assemblies 62, 162 for facilitating the attachment of the portable device 210 to a mounting surface. That is, the portable device 210 includes a housing 214 and one of the mounting assemblies 62, 162 located on the housing 214. In some embodiments, the portable device 210 may be, for example, a lighting device, a power tool, or a heating/cooling device (for example, a fan), among other possibilities. Similar to the portable devices 10, 110 described above, the portable device 210 may be a battery powered device. In other embodiments, the portable device 210 may not be battery powered. In a first orientation of the portable device 210, the magnets 74 of the mounting assembly 62 support the portable device 10 along a first support axis A1 relative to the mounting surface. In a second orientation of the portable device 210, the carabiner 166 of the mounting assembly 162 support the portable device 210 along a second support axis A2 that is angularly offset from the first axis A1. In the illustrated embodiment, the first support axis A1 extends in a direction perpendicular to the second support axis A2. In other embodiments, the first support axis A1 may extend in a direction parallel to the second support axis A2. In other embodiments, the first mounting assembly 62 and the second mounting assembly 162 support the portable device 10 on a singular support axis. In some use cases, the mounting assemblies 62, 162 may support the portable device 210 simultaneously along the first support axis A1 and the second support axis A2.

Since both of the mounting assemblies 62, 162 can stow within, or on the portable device 10, 110, the portable device 10, 110 has a smaller profile compared to other portable devices. Similarly, providing a mounting assembly 62, 162 that can stow within, or on the portable device 10, 110 reduces the possibility of the mounting assembly 62, 162 from being damaged during use. Additionally, the portable device 10, 110 is more easily mountable compared to other conventional portable devices because the portable device 10, 110 is able to be magnetically coupled to a mounting surface and/or hung from a mounting surface.

Although the disclosure has described in detail certain preferred embodiments, variations and modifications exist within the scope and spirit of one or more independent aspects of the invention as described.

Various features of the invention are set forth in the following claims.

What is claimed is:

1. A portable device comprising:
a housing;
an output element supported by the housing;
a battery receptacle supported by the housing for receiving a battery that is configured to electrically power the output element; and
a mounting assembly located on the housing, the mounting assembly including
a carabiner having a frame pivotably coupled to a side of the housing and movable between a first position, in which the frame is adjacent the housing, and a second position, in which the frame is spaced from the housing, and
a magnet located on the side of the housing and configured to magnetically couple the portable device to a mounting surface.

2. The portable device of claim 1, wherein the side of the housing is a rear side of the housing, wherein the housing includes a base configured to support the portable device and a front side opposite the rear side, and wherein the output element is positioned adjacent the front side.

3. The portable device of claim 2, wherein the rear side of the housing defines a rear surface, and wherein the magnet is located on the rear surface.

4. The portable device of claim 3, wherein the rear surface includes a recess, and wherein, when the carabiner is in the second position, the frame is located within the recess.

5. The portable device of claim 4, wherein the carabiner is flush with or recessed relative to the rear surface when in the second position.

6. The portable device of claim 1, wherein the output element is a speaker.

7. The portable device of claim 1, wherein, when the carabiner is in the first position, the frame of the carabiner surrounds the magnet.

8. A portable device comprising:
a housing;
an output element supported by the housing;
a battery receptacle supported by the housing for receiving a battery that is configured to electrically power the output element; and
a mounting assembly located on the housing, the mounting assembly including
a carabiner having a frame defining a first leg and a second leg, the frame movable relative to the housing between a first position, in which the carabiner is in a compact orientation, a second position, in which the carabiner is displaced outwardly from the housing compared to the first position, and a third position, in which the carabiner is displaced further outwardly from the housing compared to the second position and is rotatable relative to the housing.

9. The portable device of claim 8, wherein the housing includes a base configured to support the portable device and an upper side opposite the base, and wherein the carabiner extends from the upper side of the housing.

10. The portable device of claim 8, wherein the housing defines a plurality of apertures, and wherein the first leg of the carabiner is received within one aperture of the plurality of apertures and the second leg of the carabiner is received within another aperture of the plurality of apertures when the carabiner is in the first position.

11. The portable device of claim 10, wherein the carabiner is slidable relative to the housing between the first position and the second position by moving the first leg and the second leg at least partially out of the plurality of apertures.

12. The portable device of claim 8, wherein the carabiner is configured to be fixed in the second position by a detent.

13. The portable device of claim 8, wherein, in the third position, the second leg of the carabiner defines a rotational axis about which the first leg is rotatable relative to the housing.

14. The portable device of claim 8, wherein the carabiner forms a closed loop with the housing when in the first and second positions.

15. A portable device comprising:
a housing;
an output element supported by the housing;
a battery receptacle supported by the housing for receiving a battery configured to electrically power the output element; and
a mounting assembly located on the housing, the mounting assembly including
a carabiner coupled to the housing and movable between a first position, in which the carabiner is flush with or recessed relative to a surface of the housing, a second position, in which the carabiner is displaced outwardly from the housing, and
a plurality of magnets supported by the housing and configured to magnetically couple the portable device to a mounting surface.

16. The portable device of claim 15, wherein the housing includes a base configured to support the portable device and an upper side opposite the base, and wherein the carabiner is coupled to the housing adjacent the upper side of the housing.

17. The portable device of claim 15, wherein, when the carabiner is in the first position, the carabiner surrounds at least one magnet of the plurality of magnets.

18. The portable device of claim 17, wherein, when the carabiner in in the first position, at least one other magnet is positioned in a region of the housing outside of the carabiner.

19. The portable device of claim 15, wherein the carabiner is pivotably coupled to the housing.

20. The portable device of claim 15, wherein the carabiner includes a gate this is movable to an open position.
